(19) United States
(12) Patent Application Publication
(10) Pub. No.: US 2003/0009583 A1
(43) Pub. Date: Jan. 9, 2003

(54) Protocol for accelerating messages in a wireless communications environment

(75) Inventors: Chung Chan, Waban, MA (US); Lee Yiu Ming, Tsuen Wan (HK)

Correspondence Address: WEINGARTEN, SCHURGIN, GAGNEBIN & LEBOVICI LLP, TEN POST OFFICE SQUARE, BOSTON, MA, 02109, US

(73) Assignee: Mtel Limited

(21) Appl. No.: 10/156,384

(22) Filed: May 28, 2002

Related U.S. Application Data
(63) Continuation-in-part of application No. 09/847,618, filed on May 2, 2001.
(60) Provisional application No. 60/294,050, filed on May 29, 2001.
(60) Provisional application No. 60/296,079, filed on Jun. 5, 2001.

(51) Int. Cl. G06F 15/16

(52) U.S. Cl. 709/236; 709/247

(57) ABSTRACT

A communications protocol (M-Protocol) that rides under the Transmission Control Protocol (TCP) protocol of the Internet and many other communications networks such as HTTP/SSL, SMTP, POP3, NNTP, allows capabilities required for compression and encryption of data files to be provided over the commonly used communication networks. The M-Protocol, riding under the TCP protocol, works like a TCP gateway but with ability to compress and encrypt data. The data integrity functions of TCP are undisturbed. System messages establish the M-Connection. Applications of the M-Connection include Web browsing from a portable wireless handheld device and integrating Voice over IP onto a Data line in a GRPR environment.

### CROSS REFERENCE TO RELATED APPLICATIONS

This patent application is a continuation in part of patent application Ser. No. 09/847,618 filed May 2, 2001 and claims priority under 35 U.S.C. §120 to that application. The disclosure of this application is incorporated herein by reference. This patent application claims priority under 35 U.S.C. §119(e) to provisional patent application serial No. 60/294,050 filed May 29, 2001 and provisional patent application No. 60/296,079 filed Jun. 5, 2001, the disclosures of all of which are hereby incorporated by reference.

### STATEMENT REGARDING FEDERALLY SPONSORED RESEARCH OR DEVELOPMENT

N/A

### BACKGROUND OF THE INVENTION

The present invention relates generally to a system tailored for wireless data communication and specifically to a protocol for carrying most data files and packets through such a communications system. The existing wireless mobile phone infrastructures are implemented in a number of standards including: the Global System for Mobile Communication (GSM) including its implementation of the General Packet Radio Service (GPRS) or Code Division Multiplexing Algorithm (CDMA). This infrastructure supports international voice calling within one standard area but does not support mobile phone data transfer. In addition, the existence of multiple standards presents difficulties when a customer using a one standard tries to call a country utilizing another standard. For instance, the majority of the United States utilizes CDMA and Time Division Multiplexing Algorithm (TDMA), while much of Asia and Europe use GSM and GPRS. Therefore, while a US based mobile user can call a land-based phone worldwide, that user cannot access a mobile user in Europe.

The difficulties are compounded when trying to send data rather than voice globally utilizing mobile technology. In those places where a mobile network for data does exist, it has limited speed and span and is not designed for international compatibility. In the CDMA realm, the maximum speed is approximately 64 Kb/sec with reliable data transmission usually utilizing 19.8 Kb/sec. In the GSM realm, 9.6 Kb/sec is the general transmission speed while in the realm of GPRS, general data communication is theoretically possible at 115 Kb/s but in reality is limited to approximately 30 Kb/s, although there are limited areas where higher bandwidths are available. These speeds must be contrasted with the current data rates of a T1 land line of approximately 1.5 Mbits/sec.

The best prospect for increasing this speed is the implementation of the General Packet Radio Service (GPRS) protocols and the 3^{rd} generation (3G) infrastructures worldwide. This implementation is delayed waiting for wider implementation of the GSM network and higher speed transmission rates utilizing GPRS over GSM. In addition, implementation of GPRS is delayed by the requirement that the GSM operations cannot be inhibited during GPRS implementation. Currently, the performance of GPRS over GSM is comparable to GSM with conventional data mechanisms because GPRS and GSM share a bandwidth. Even if GPRS did not have performance bottlenecks, the availability of GPRS handsets is limited. Because the majority of users usually start to use data transmission over a mobile network for Emails, they are unlikely to purchase the expensive handsets needed for GPRS. Until performance improves, the added cost of GPRS will not be justified.

Even if GPRS over GSM met performance objectives, the compatibility problems among the GSM, GSM/GPRS and CDMA regions of the world would persist. Handsets designed for one standard are currently not compatible the other standards. Even within the GSM realm, a GPRS compatible handset is limited to that area of GSM coverage that implements GPRS.

### BRIEF SUMMARY OF THE INVENTION

A method for encapsulating a message in a sequence of packets being transported by the TCP/IP protocol comprises adding a data transformation header to the front of the data file, the data transformation header specifying processes applied to the data field. The processes may be selected from the group of compressing the data file, encrypting the datafile, incorporating commands to server applications in the data file and error checking the encapsulated message.

A packet network using the encapsulated packets comprises a sending node for receiving a communication from an application resident on the node, for processing the data file according to the client node's preset conditions thereby creating a processed data file, and for incorporating a control word identifying the processes used in a data transformation header appended to the processed data file to form a datagram. The sending node utilizes the TCP/IP protocol to forward the datagram on the packet network to a receiving node for receiving the datagram. The receiving node has the capability for interpreting the control word of the data transformation header to reconstruct the data file and for passing the data file to an application on the receiving node.

A system for delivering a voice message to an intended recipient that uses the packet network comprises a converter program for converting a voice signal to digital packets for transport over an IP network. The voice signal may be received through a GSM or GPRS communications network. A packager program places the digital packets in a compressed format and an acceleration program determines a best route to a node near the recipient. In the node near the recipient, an unpacking and converting program for constituting the received voice message into a format needed by the recipient processes the received packets. Other aspects, features, and advantages of the present invention are disclosed in the detailed description that follows.

### BRIEF DESCRIPTION OF THE SEVERAL VIEWS OF THE DRAWING

The invention will be understood from the following detailed description in conjunction with the drawings, of which:

FIG. 1 is a system that could use the protocol of this invention;

FIG. 2a is a diagram of two tightly coupled network territories according to the invention;

FIG. 2b is a diagram of the environment in which the invention operates;

FIG. 3 is a structural diagram of a system using the protocol;

FIG. 4a is a diagram of packets carrying the packet(s) according to the invention;

FIG. 4b is a diagram of one form of a General Packet Structure according to the invention;

FIG. 4c is a diagram of another form of a General Packet Structure according to the invention;

FIG. 5 is a diagram of a Control Flag Block according to the invention;

FIG. 6A is a diagram of a CLIENT_LOGIN Control Message according to the invention;

FIG. 6B is a diagram of a CLIENT_LOGIN_WITHKEY Control Message according to the invention;

FIG. 6C is a diagram of a CLIENT_LOGIN_MAGIC Control Message according to the invention;

FIG. 6D is a diagram of a CLIENT_LOGIN_MAGIC_WITHKEY Control Message according to the invention;

FIG. 6E is a diagram of a CLIENT_SETKEY Control Message according to the invention;

FIG. 6F is a diagram of a SERVER_AUTHPASS Control Message according to the invention;

FIG. 6G is a diagram of a SERVER_AUTHFAIL Control Message according to the invention;

FIG. 6H is a diagram of a SERVER_MESSAGE Control Message according to the invention;

FIG. 6I is a diagram of a SERVER_ERRORMESSAGE Control Message according to the invention;

FIG. 6J is a list of the error codes available according to the invention;

FIG. 7 is a flowchart illustrating the encoding procedure of the content field according to the invention;

FIG. 8 is a flowchart illustrating the decoding procedure of the content field according to the invention;

FIG. 9 is a flowchart illustrating the smart compression procedure according to the invention;

FIG. 10 is a flowchart illustrating the authentication procedure according to the invention;

FIG. 11 illustrates use of the protocol according to the invention to allow web browsing on The network; and

FIG. 12 illustrates the use of the protocol according to the invention for VoIP and Data.

### DETAILED DESCRIPTION OF THE INVENTION

A gateway and total solution system (GTSS), as disclosed in co-pending applications Ser. Nos. 09/564,352, 09/694,643 and 09/847,618 filed May 1, 2000, Oct. 23, 2000 and May 2, 2001 respectively, herein incorporated by reference, provides data access services to a mobile user. This invention extends the GTSS to facilitate global data communications. The description of the extensions is based on the summary of the GTSS below.

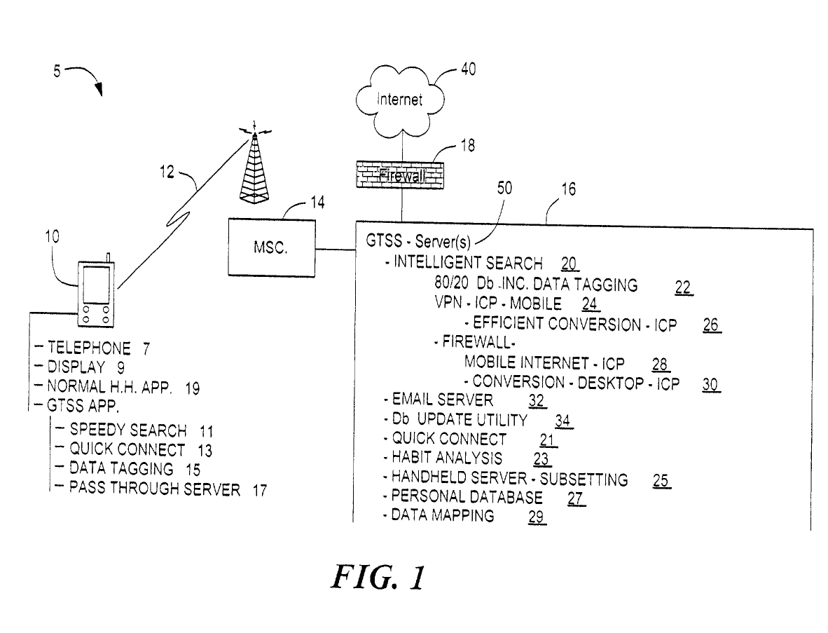

FIG. 1 is a block diagram of the GTSS 5 as previously described, showing support for Internet access and digital transmission for extended handheld units 10 using one of the GSM, GPRS, CDMA or Bluetooth wireless communications standards. The GTSS components are the extended handheld unit 10, with special software providing the functions of a mobile telephone and a portable PC or PDA, and a GTSS server 16 providing services to the handheld 10 and providing access to the Internet 40 and the services delivered through it. The handheld 10 connects through a wireless network 12 and a Mobile Switching Center (MSC) 14 to a GTSS server 16.

The GTSS 5 provides services targeted for two results, improving the communication speed to the handheld 10 and providing content tailored for the handheld's visual capabilities. GTSS server 16 is replicated and distributed within a territory proximate to the users. The servers 16 are interconnected for specific benefits discussed below and hold the content that the user desires as physically close to the user as possible. The speed provided by these support services compensates for the cost structure and low bandwidth of wireless communication and the limitations of the screen of handheld unit 10. Speed services are located both in the handheld unit 10 and the GTSS server 16. Special content is needed to present a wide variety of information in formats adapted to the handheld screen while utilizing the speed services to increase user satisfaction.

The handheld 10 is loaded with traditional PDA applications 19 such as address book, memo, and to-do list that use the display 9 and the telephone 7 and a set of GTSS applications. One previously disclosed handheld-resident GTSS application, speedy search 11, facilitates the creation of search requests that retrieve precisely the information wanted from the Internet 40 or databases (not shown) without requiring a series of time consuming dialogs traversing the wireless network. Speedy search 11 augments the wide ranging search facilities already available for the Internet 40 by guiding the user to precisely define what is wanted before the search is conducted. With the speedy search, the number of hits that require a dialog between the handheld 10 and server 16 is limited. Because multiple search interactions are not required, the user receives the information desired more quickly.

A second previously disclosed handheld resident GTSS application is a quick-connect service 13; a service that identifies the user and his authorization as the handheld unit 10 is connecting to the server 16. The server component 21 of the quick-connect service not only establishes the connection with minimal interactions but also assures that each transmission to the handheld will fill an entire screen. The server quick-connect facility 21 also maintains a running status of each active connection to enable a communications ride-through in case of a wireless service outage. On reconnect of a lost connection, the server 16 transparently reestablishes the link and resumes the interrupted transaction from the last completed dialog.

To further speed interactions between the handheld 10 and the server 16, data tagging 15 is implemented. This is a mechanism where the dynamic portions of the data are tagged with a time-stamp. When using data tagging 15, the handheld unit 10 reports the timeliness of data already resident in the handheld 10 and only requires downloads of updates. This feature includes server support for data field tagging 22 with the resultant shortened transmission times that provide the user with improved usability. This feature is used in conjunction with applications that dynamically display information, such as the changes of stock prices in real time. The current stock price applications displayed via desktop web browsing refresh the entire price form, rather than just the prices. Data tagging makes this is unnecessary and speeds the real time update of just the price quote.

Some handheld units will utilize a previously disclosed application that allows the handheld to act as a pass-through server 17 for a number of other handhelds. This pass-through application 17 takes advantage of the Bluetooth short distance transmission technology. It re-transmits the data the handheld 10 received from the GTSS server 16 over the wireless connection to other handhelds 10 within approximately ten meters of the pass-through handheld server. The pass-through application 17 will also collect and consolidate inputs from the other handhelds 10 to provide an interactive experience for all the handheld users.

Speed also implies that the server 16, the main data portal for the handheld unit 10, has specialized capabilities. One of these capabilities is a database 22 of information formatted as screens tailored for the handheld unit. This database may be entirely resident on the local server 16 or may be distributed over a number of databases accessed by communications including the Internet 40. For information that has not been formatted for a handheld 10, a GTSS formatter application converts the desktop-formatted pages to handheld screen format. This conversion may be a straight transform of one desktop page to a number of handheld screens, a conversion according to some optimized conversion schemes or a tailored conversion, approved by the information content provider (ICP), that optimizes the desktop presentation for the handheld environment.

A major improvement in apparent speed comes about because the server 16 is able to directly access an extensive database 22 of information that has been prestored based on the user's prior usage and projected needs. Such a database, termed an 80/20 RIDb 22 avoids the need to wait for a full Internet transaction to send data to the handheld unit 10. The 80/20 RIDb 22 includes full motion video formatted for the handheld screen in addition to text and graphics information. An update utility 34 keeps the 80/20 RIDb 22 current in real time by monitoring the page-based data and updating the corresponding screen-formatted data whenever the page-based data changes.

The server 16 that is the primary contact for a particular user is a member of a set of GTSS servers 16 tailored for mobile users. High speed interconnects between these servers 16 allow the specially formatted information in one to be available to all. An intelligent search engine 20 distinguishes between searches that need to use the Internet 40 and searches that are centered on the set of GTSS servers 16 to improve the speed of service to the users. In addition, as the users' access habits change, the utility repositions data so that frequently accessed data is in the high-speed databases. The intelligent search engine 20 is updated with the current location of all data. All secure transactions among the GTSS servers 16 use protocols implementing security provisions to create virtual private networks (VPNs) 24 assuring the data is not corrupted.

The features that support special content for the handheld mobile user include a personal database application 27 that stores the user's files in the GTSS databases. This application 27 allows the user to access their information without regard to the type of connection being used.

An ICP update application 28, which allows content providers to submit updates to stored desktop web pages and have that update be formatted both for the desktop and for the handheld screen, further supports the speed of delivery of the special contents. Even though the updates were created over a VPN, the updates are authenticated before being entered into the master database.

For those information providers who choose not to provide their data formatted as handheld screens on the Internet, but who provide pre-approval, fast custom conversion applications 26 are supplied to improve the speed of screen information access. A conversion application 30 converts a general desktop web page to a handheld format. Its use is conditioned on the handheld user's explicit request for the conversion. Grouping information based on the user's access and holding that information in the most accessible storage media is an implemented capability. A database update application 34 applies artificial intelligence techniques to the update of information. It continues to monitor the database to improve access after a user initially subscribes to information.

For reliability and capacity, the functions of the GTSS server 16 are implemented in a number of designated servers. A proxy server fields the user communications, directs the requests to the appropriate server within GTSS, and sends data back to the handheld units. It makes the entire GTSS system look like one entity to handhelds connected to the GTSS.

The proxy server uses a mapping application 29 to retrieve data. The mapping application 29 maintains a database of the data available, determines which location can provide the fastest-response data and retrieves the data from there. The database with the fastest-response is the 80/20 RIDb 22 located in the local site. In descending order of responsiveness, the mapping application 29 accesses data from 80/20 RIDb, other databases connected by dedicated lines to this site (not shown), Information content providers 24 (ICP) on Virtual Private Internets (VPN) or Intranets, ICPs that need converting 30 on a VPN, ICPs providing handheld formatted data external to the GTSS 16 and ICPs providing desktop data on the Internet 40.

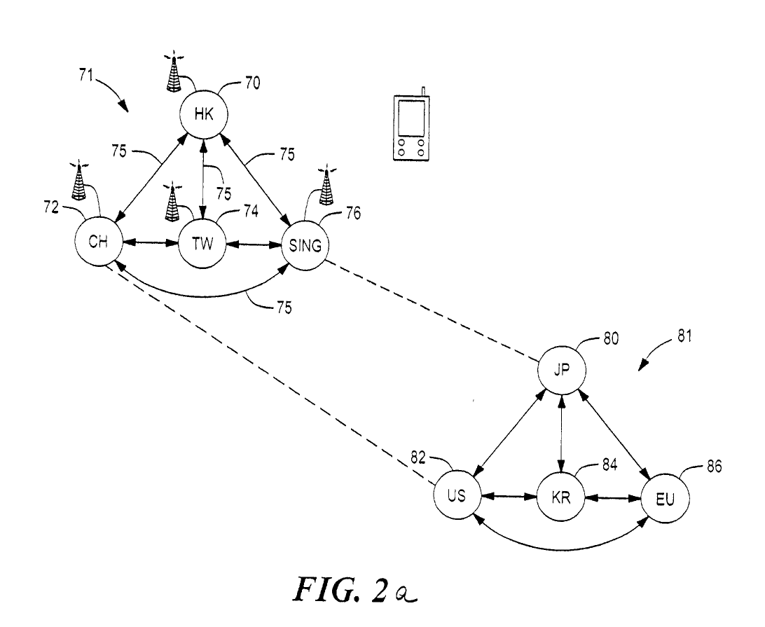

FIG. 2a illustrates a territorial connection of GTSS servers 5 previously disclosed where the regional servers within a territory are tied to other servers within the territory. For instance, in the Chinese Territory 71 shown, the regional servers for Hong Kong 70, China 72, Taiwan 74 and Singapore 76 are connected by high speed intelligent links 75 using landlines, optical links or high speed wireless links. These links enable the regional servers 70, 72, 74 and 76 to share data in a transparent manner limiting duplication among the regions. In the previously disclosed implementations, these links are not usually part of the Internet 40, but form a Virtual Private Net (VPN) with no additional need for security. Some regional servers maintain connections to other territories 81, but the transmissions speeds possible usually limit the response time of these connections. Therefore, the databases stored at the distant servers are not as readily shared as those within the territory.

The Global Data Access Network (GloDAN) extends the capabilities of the GTSS described above by extending the capabilities of the GTSS sites (EGTSS), providing more applications for the handheld unit, and adding a central database base that facilitates interconnecting the individual EGTSS sites as equals. FIG. 2b illustrates this Extended total fully integrated solution. The user 10 connects to the wireless telecommunications carrier 60 via industry standard protocols. The EGTSS 114 connects to the wireless network through the Message Switching Center (MSC not shown). The EGTSS connects to the Internet 40 and stores known industry applications such as mobile applications 62, mobile-commerce applications 64 and specific enterprise applications 66 for downloading to handhelds 10. The EGTSS 114 also contains an integrated solution to service the mobile users composed of a gateway application 116, personalization services 68, acceleration server 90, conversion applications 92 and search engine 94. Location-based technology 96 and security features 98 may be implemented for specific handheld users and is integrated when used.

Taking notice of the extensive telecommunications and Internet networks implemented, the EGTSS is designed to take advantage of these networks to provide a virtual worldwide wireless data network. This virtual network allows users in an area of the world using one wireless communications standard to seamlessly access data being provided on a different communications standard (wireless or land-based) in another part of the world.

In conjunction with providing this virtual network, EGTSS implements support mechanisms to overcome the data handling limitations of current wireless networks. Analyses of past transaction sequences predict users' behaviors and update local resources so that the data expected to be requested is available locally. By this means, the apparent response time of the system is significantly improved. Compression techniques, parallel verification, and directed use of the known high-bandwidth paths in the Internet are used to provide an adequate response rate for users' needs. Modular design of the system enables the utilization of improvements in the wireless systems as they are implemented in the future.

This system provides a complete technical solution to implementing mobile data applications on existing GSM, TDMA, Cellular Digital Packet Data (CDPD), CDMA and GPRS infrastructures. The solution functions using the current bandwidth available for data transfer on the wireless infrastructures and will utilize higher bandwidths, as they become available. By improving existing wireless facilities only when needed, a global mobile data network is formed at minimal cost.

A communications protocol (M-Protocol) that can ride under the Transmission Control Protocol (TCP) protocol of the Internet and many other communications networks such as HTTP/SSL, SMTP, POP3, NNTP, allows capabilities required for EGTSS services, such as compression and encryption, to be provided over the commonly used communication networks. Because the M-Protocol rides under the TCP protocol, it works like a TCP gateway but with ability to compress and encrypt data. The data integrity functions of TCP are undisturbed. The EGTSS nodes expect the M-Protocol so that links among the EHU's and EGTSS nodes form an integrated M-Connection.

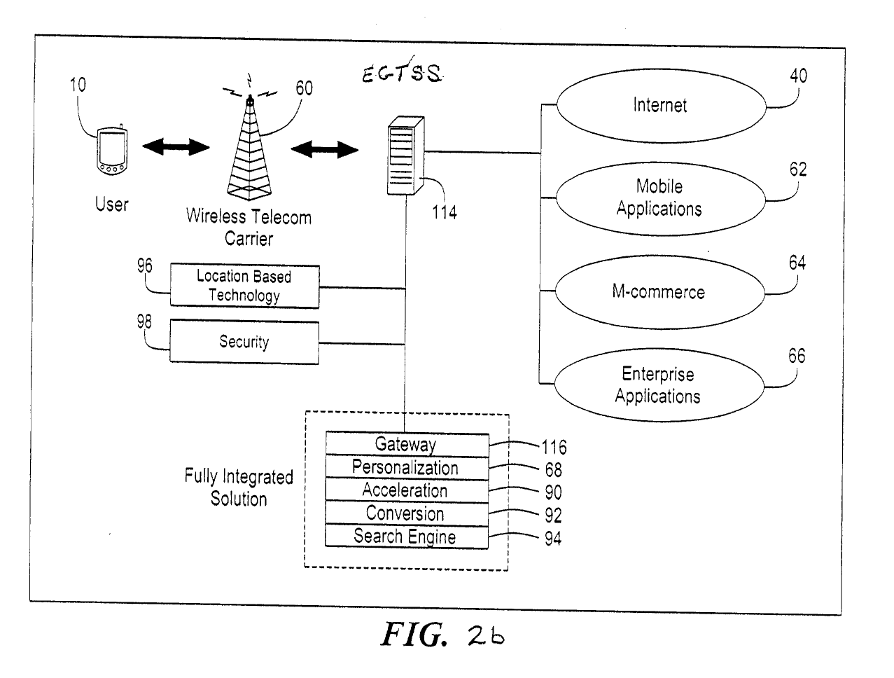

FIG. 3 shows an M-Protocol structure. Client applications run on the extended handheld units (EHU). The EHU is connected to an M-Protocol Client (M-Client) using a TCP connection such as a local loopback or LAN connection. Alternately, the M-Client and EHU may be co-resident in the EHU. The M-Client establishes an M-Protocol connection to the M-Protocol Server (M-Server) and then handles the packaging of data into and out of the M-Protocol for the client application. Similarly, the M-Server performs the same services for the Back-end server and its applications. The M-Client and M-Server, the M-Interfaces, operate as digital codecs and will cooperate despite many hops of the Internet as long as a TCP connection is between them. The M-Protocol is a bi-directional protocol where data passed through the client-server connection is being compressed and/or encrypted, and the data is re-constructed in both ends and then piped to the destination. In addition, on the server side, user authentication is also performed.

M-Client receives data from a end-user application such as a web browser or email client. It encodes this data into a compressed and encrypted structure, and then sends it to the M-Server. Whenever data arrives from the M-Server, M-Client decodes the structure into plain data and pipes it to the destination application; or performs internal processing based on a structured embedded command signal. M-Server acts in a complementary manner to its M-Clients. It decodes structured data received from M-Client. It pipes plain data to back-end applications like an email server, or performs internal processing based on the structured embedded command signal. Whenever data arrives from the back-end application server, M-Server encodes the data and sends it to M-Client. To summarize, data flow between M-Server and M-Client can be either encoded data or command signal. Encoded data are generally compressed and optionally encrypted, thus the M-Protocol accelerates the data transmit rate and secures the data.

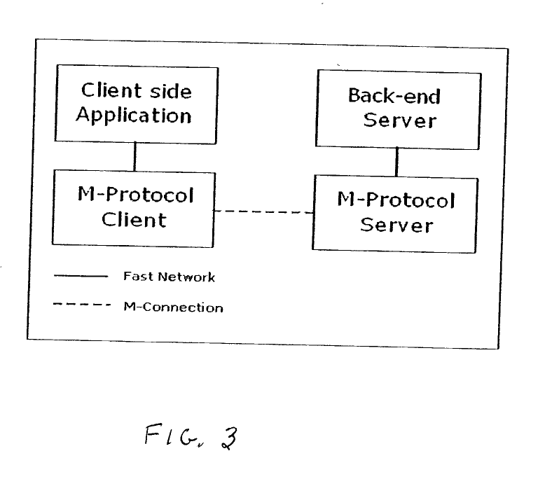

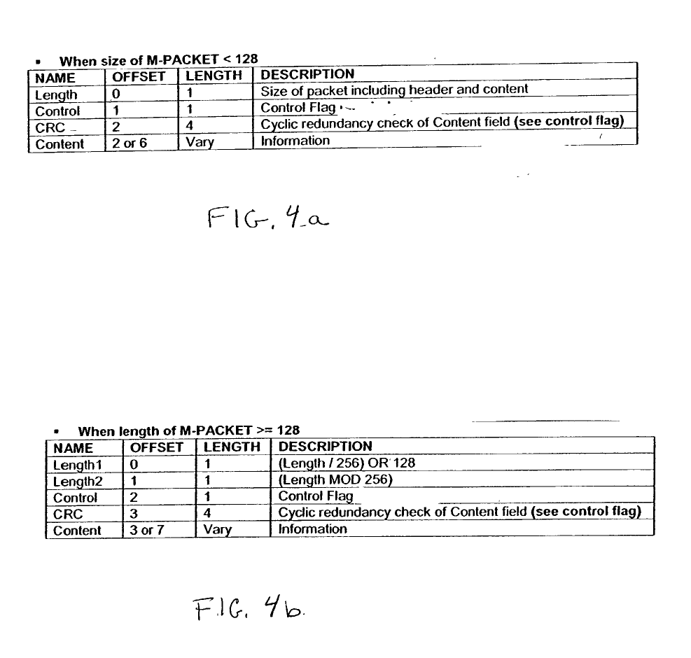

The M-Protocol utilizes an M-Packet as shown in FIGS. 4a, 4b, and 4c to encapsulate control and data. FIG. 4a illustrates a sequence of packets carrying the packet(s) for the M-Protocol. The TCP/IP header 42 as is known in the industry carries the information needed for routing and packet integrity. The M-Header 44 identifies the parameters to be used in the M-Protocol connection established therein. The M-SY Header is included in M-Protocol System messages to carry further M-Connection control information. The content field 46 carries the content of the message and may span multiple packets. FIG. 4b illustrates the structure of the M-Packet when the packet is less than 128 bytes in length and FIG. 4c illustrates the structure of the M-Packet when the packet is greater than 128 bits in length. The header of the M-Packet encompasses bytes for length, control flags and cyclic redundancy check (CRC) of the content field. The content field of the M-Packet carries content in specified bytes that are interpreted as defined by the control flags.

The length bytes specify how many bytes of information are in the packet. For short packets, only one length byte is required, and the lower 7 bits of the byte specify the length. For long packets, the first length byte specifies that the word count is greater than 128 and how many multiples of 256 are in the packet and the second length byte specifies the value of the length MOD 256. The control flag byte specifies the coding of the remainder of the packet—header and content—as detailed below. The CRC bytes hold the value of the CRC for use in validating the content field integrity.

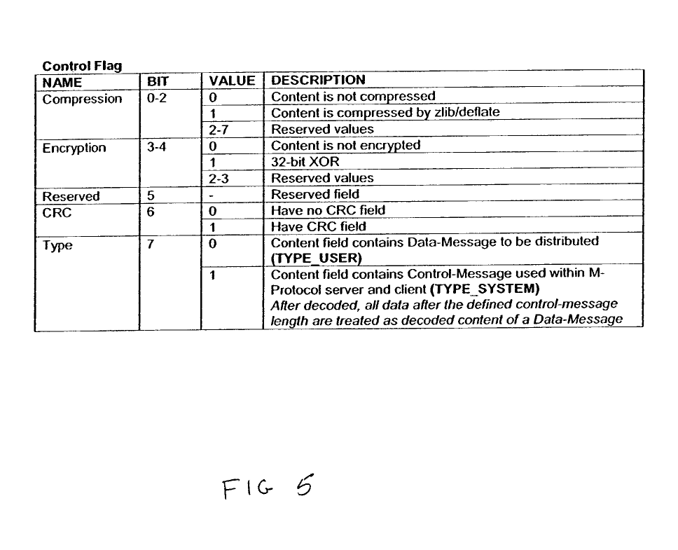

The control flag byte is illustrated in FIG. 5. Three bits are dedicated to compression definition. Code 000 specifies that the data in the content field is not compressed. Code 001 specifies that the data in the content field is compressed using the zlib/deflate algorithm as is known in the art. M-protocol specifically supports zlib because it is designed to be a free, general-purpose, legally unencumbered lossless data-compression library for use on virtually any computer hardware and operating system. The compression method currently used in zlib essentially never expands the data and achieves approximately 2:1 compression using less than 64 KBytes of memory on both sender and receiver. Six additional codes are available to specify other compression algorithms.

Two bits are used to specify the encryption used. Code 00 specifies no encryption, while code 01 specifies 32-bit XOR encryption as is known in the industry. Two additional codes are available to specify other encryption methods.

One bit specifies whether the CRC field contains information. One bit is reserved and a last bit specifies the type of message, User or System, contained by the content field. User messages contain only data in the content field. System messages precede the data with a control header.

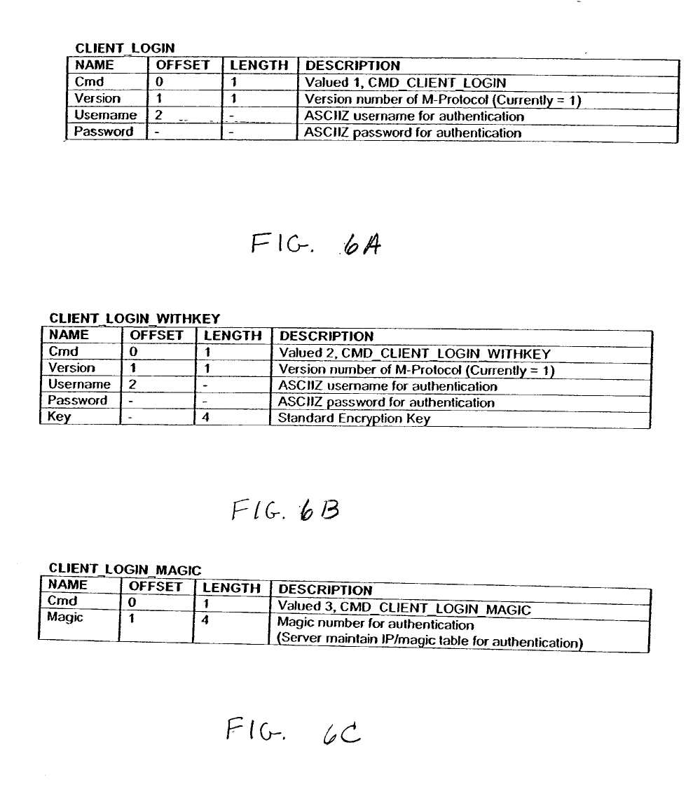

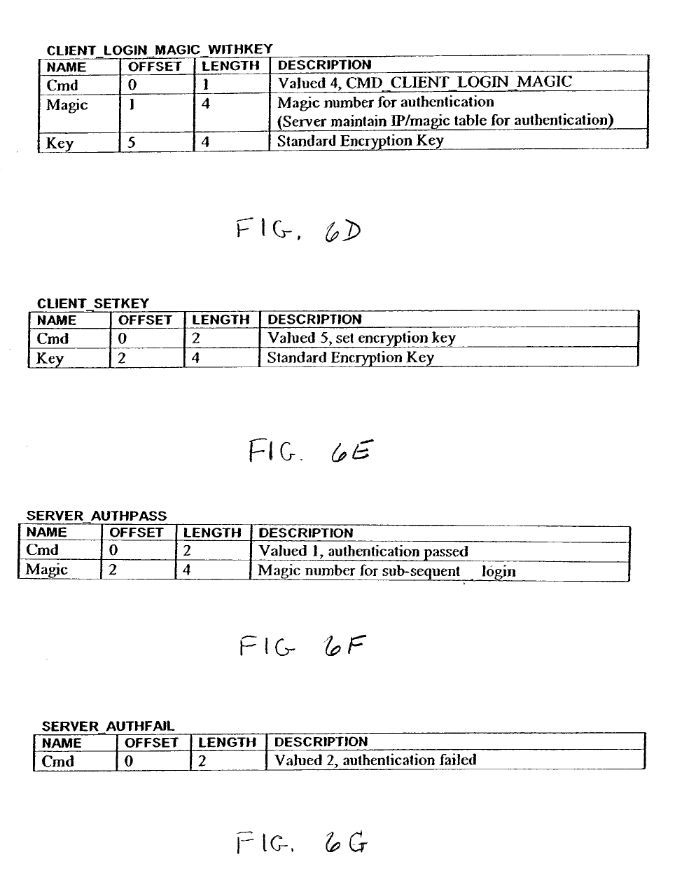

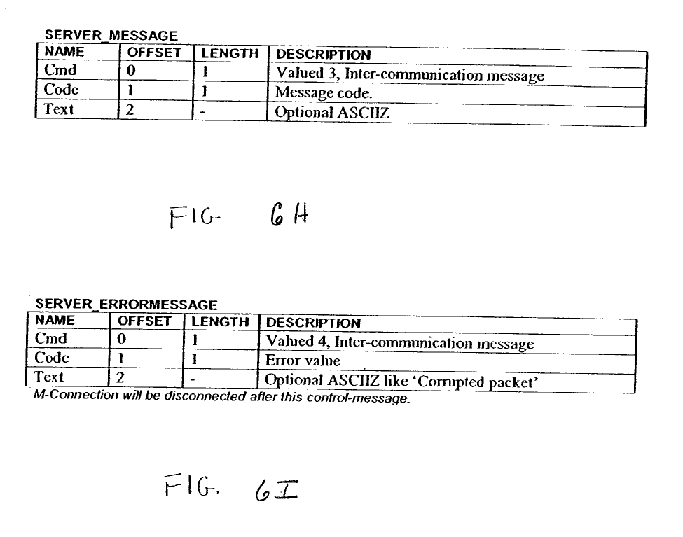

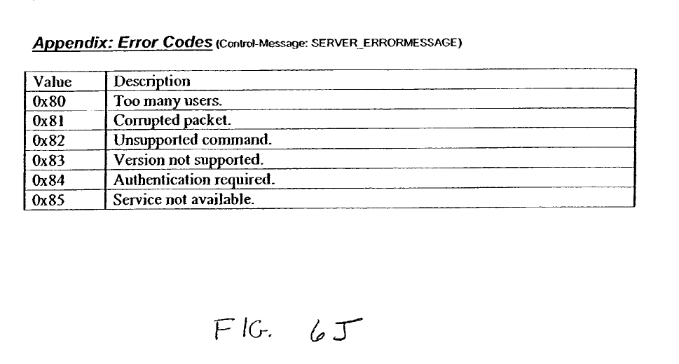

FIG. 6 illustrate the control headers sent in System message content fields. These headers are broken into two types—control headers from the client to the server and control headers from the server to the client. The client-to-server control headers are used to establish connection with the server or change an operating parameter of an already established connection. The client-to-server control header always contains a command and optionally contains version, username, password, encryption key, and authentication information.

The CLIENT_LOGIN control header is illustrated in FIG. 6A. The Cmd and Version field identify the Command and the Version of the M-Protocol being used respectively. The Username and Password are supplied as null-terminated ASCII strings to be used for authentication. Username and Password are parameters that have an unspecified length.

The CLIENT_LOGIN_WITHKEY control header is illustrated in FIG. 6B. The Cmd, Version, Username and Password are used as in the CLIENT_LOGIN control header and the Encryption Key to be used with this client is supplied as a 32 bit (4 byte) value.

The CLIENT_LOGIN_MAGIC control header is illustrated in FIG. 6C. This login is used when magic authentication, as is known in the industry, is being used for the system. A database in the server has already been loaded with a Internet Protocol (IP) address/magic number table. Therefore, the Magic field replaces the Username and Password fields in the control header for this login.

The CLIENT_LOGIN_MAGIC_WITHKEY control header is illustrated in FIG. 6D. Here, the Encryption Key is used with the Magic authentication.

The CLIENT_SETKEY control header is illustrated in FIG. 6E. This command header allows a client to change the Encryption Key at any point.

The SERVER_AUTHPASS control header is illustrated in FIG. 6F. The message carrying this header is a response to a client-to-server system message with a password authorized login command. This response acknowledges the successful login and provides a magic number for use in subsequent logins.

The SERVER_AUTHFAIL control header is illustrated in FIG. 6G. The message carrying this header is a response to a client-to-server system message with a login command that failed. The M-Protocol connection is terminated after a message with this header is sent.

The SERVER_MESSAGE control header is illustrated in FIG. 6H. The message carrying this header can include an ASCII message for the client. The Code and TEXT fields are provided for definition by the applications running on the systems.

The SERVER_ERRORMESSAGE control header is illustrated in FIG. 6I. The message carrying this header can include an ASCII message for the client in the TEXT field, but since the error values in the CODE field as listed in FIG. 6J cover common errors, the message field usually does not have to be used. The M-Connection will be disconnected after this control message.

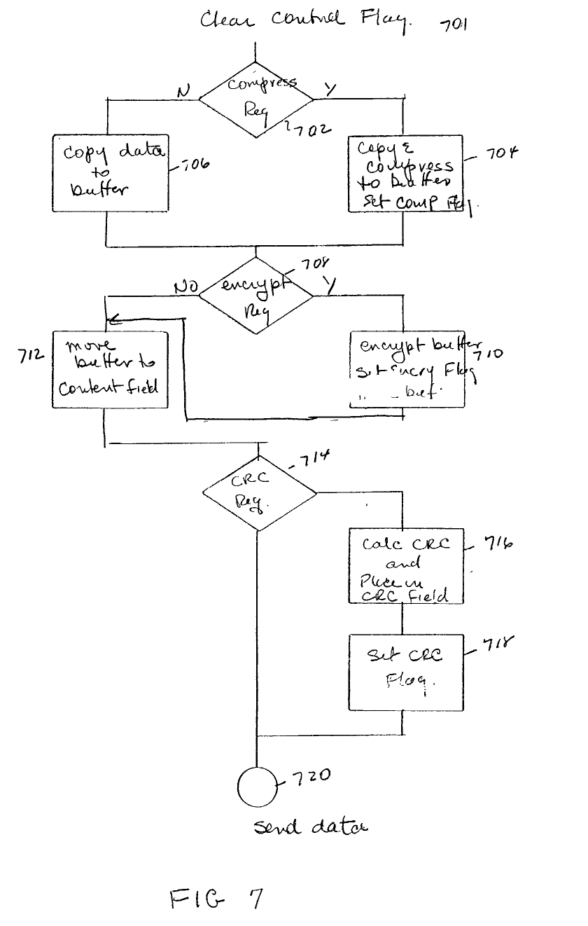

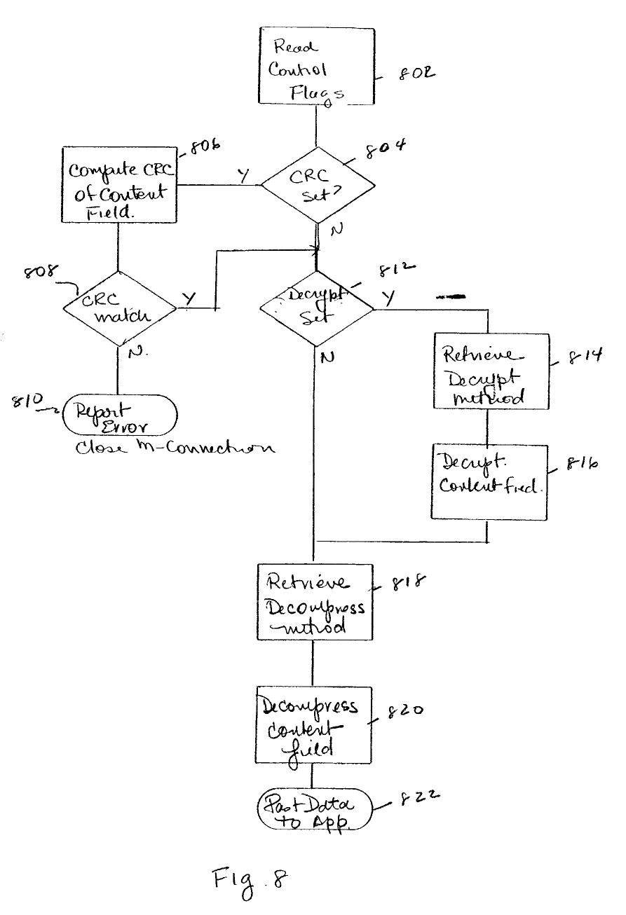

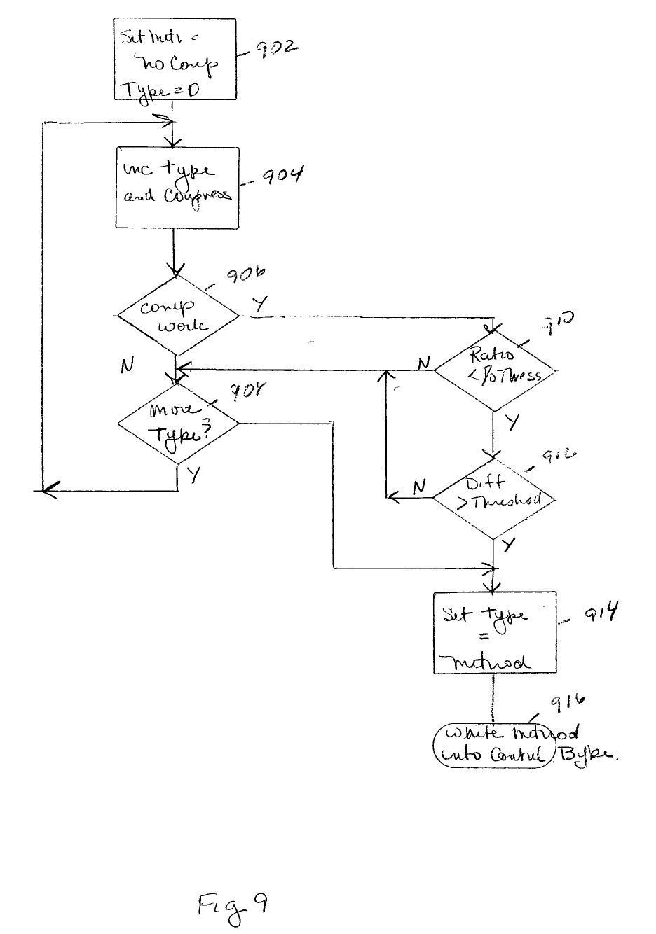

FIG. 7 illustrates a procedure according to the invention used to encode the content field for transmission over the M-Connection. The control flags are first cleared, step 701. The M-Interface then checks whether to compress the data, step 702. If compression is to be used, the data in the application data buffer is copied to the interface buffer and supplied to the compression algorithm described below. The resultant compressed data is stored in the interface buffer. The compression algorithm places a compression code in the appropriate bits of the control flag. 704. If compression is not to be used, the data is moved into the interface buffer, step 706.

The M-Interface then checks whether to encrypt the data, step 708. If encryption is to be used, the encryption algorithm encrypts the data in the interface buffer while moving the data to the content field and places the encryption code in the appropriate bits of the control flag, step 710. If encryption isn't being used, the data is moved into the content field unchanged, step 712. The M-Interface checks whether the message should be sent with a CRC, step 714. If CRC is being used, the CRC of the content field after compression and/or encryption is calculated and placed in the CRC field, step 716, and the CRC bit in the control flag is set, step 718. The M-Interface is ready to send the data, step 720.

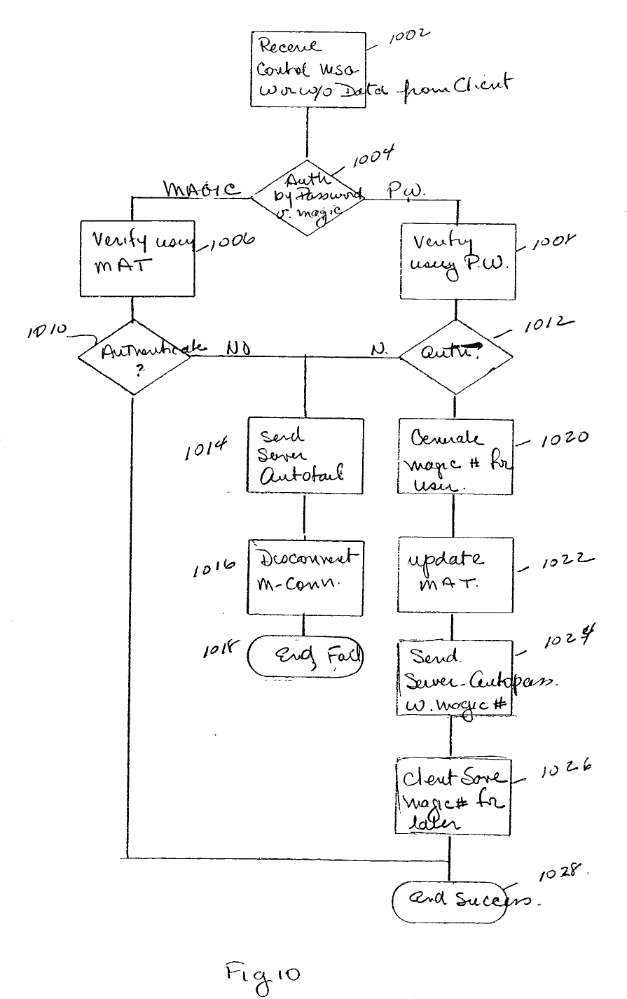

FIG. 8 illustrates the procedure used by the M-Interface to process the content field received over the M-Connection. The control flags are extracted from the packet, step 802, and used to control the sequence of actions. The CRC bit is tested, step 804, and if set the CRC of the content field is calculated, step 806. The calculated CRC and the transmitted CRC are compared, step 808 and if they do not agree, the corrupted packet error message is sent and the M-Connection is disconnected, step 810. If the CRC codes match, the encryption flag is checked, step 812. If this message is encrypted, the encryption method is retrieved, step 814 and the content field is decrypted, step 816. The last step in reconstituting the content field is the decompression. The compression bits in the control word are retrieved and used to select the decompression method, step 818. Once the content field is decompressed, step 820 the data is passed to the application.

FIG. 9 illustrating a procedure according to the invention used to select a compression algorithm that provides a set level of compression, if possible, for a specific set of data. The procedure starts by zeroing the compression type indicator, step 902. The indicator is incremented and the contents of the data buffer is compressed and stored in the content field buffer using the method indicated by the type indicator, step 904. The size of the original buffer and compressed buffer are compared to see if the compression succeeded at all, step 906. If there was no compression, the procedure checks whether there are more types of compression to try, step 908. If there are more types, the procedure returns to step 904 to try the next type. If there are no further types of compression, the procedure advances to step 914 described below. If the test in step 906 shows that there was some compression, the compression ratio (compressed size divided by original size) is calculated and compared against a ratio threshold, step 910. If the ratio is larger than the ratio threshold, the compression was not sufficiently efficient and the procedure proceeds to step 908 to determine if there are more compression types to try. If the ratio is smaller than the ratio threshold, the difference in size is calculated (original size—compressed size). If the difference is greater than a difference threshold, step 912 the procedure advances, but if the difference is smaller, the compression was not sufficiently efficient and the procedure proceeds to step 908 to determine if there are more compression types to try. When an adequate compression algorithm has processed the data, or when no further algorithms are available to improve on the compression, the compression type indicator is stored in the control word as the compression method, step 914, and the compression procedure is complete, step 916.

One an example of a compression method that could be utilized is one that replaces sequences of characters with a shorter symbol. The method analyzes the entire data message computing the frequency of occurrence of sequences of characters in the file. Using preset criteria to select sequences to be replaced, the file is compressed by replacing sequences having multiple occurrences with a shorter symbol.

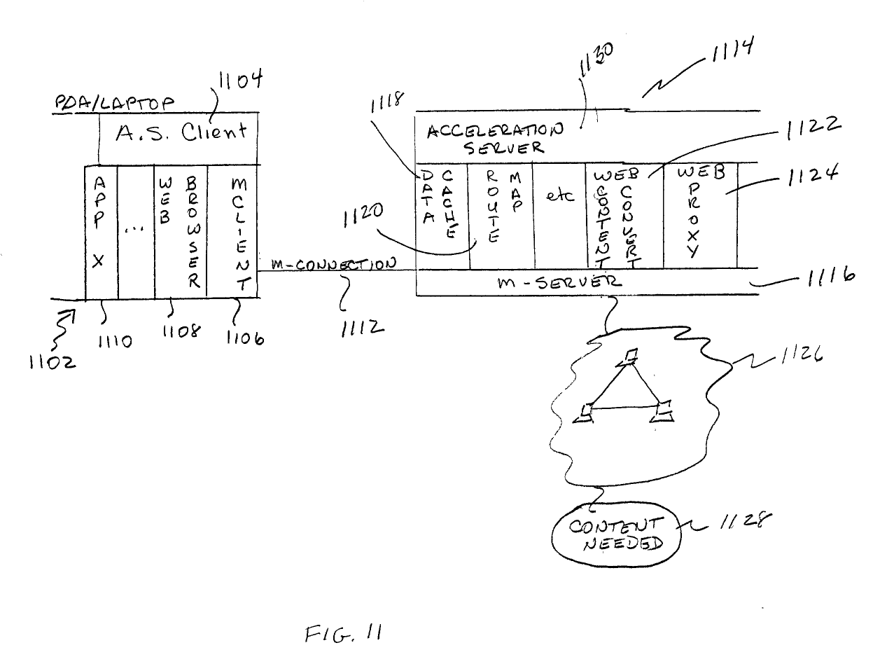

FIG. 10 illustrates an authentication procedure according to the invention. Two procedures are shown supported; the conventional username/password authentication and the authentication procedure known in the industry as the magic number procedure. The experienced user will appreciate that further procedures could be supported. Authentication starts when an M-Server receives a control message, regardless of whether data accompanies the message, step 1002. The procedure first checks which authentication method is being used, step 1004. For magic authentication, the procedure checks that the magic number supplied and the user's IP address match the data in the magic authorization table, step 1006. If there is a match, step 1010 authentication is complete and a success message is sent to the M-Server requesting the authentication, step 1028. If there is no match, authentication has failed. The server sends a SERVER_AUTOFAIL message to the client, step 1014 and disconnects the M-Connection, step 1016.

For password protection, the server checks the username and password supplied with the login message against a database in the server, step 1008. If the authentication fails, step 1012, the error sequence previously described starting at step 1014 is used. If the user is authenticated, a magic number is generated for-that user, step 1020, an entry is placed in the Magic authorization table, step 1022 and a SERVER_AUTHPASS message with the magic number enclosed is sent to the user, step 1024. The authentication returns control to the M-Server, step 1028 after authentication has completed successfully.

Data Acceleration is a prime use for the M-Protocol. An Acceleration Server designed to improve the response time for communications with the EHU has been described in prior disclosures, but further acceleration is desirable. Typically an Acceleration Server resides in a server, or is replicated in multiple servers, and acts as an application proxy for applications that seem to run completely in an EHU but actually need resources available on another computer. The client part of the application communicates with the client-side component of an Acceleration Server that usually resides in the EHU and acts as a normal proxy always communicating with the server-side of the Acceleration Server. The server-side of the Acceleration Server executes the application proxy tasks. Alternately, an Application Server client can keep a list of the regional server side IP addresses and automatically connect to the nearest regional Application Server for rapid connectivity and service while roaming in the region.

The main function of the Acceleration Server has been to reduce the data retrieval time over existing networks through document caching and compression. The updated Acceleration Technology has 3 parts: —Document Caching, Content Compression (all TCP) and Content Conversion. Document caching has been addressed in prior disclosures. Prior attempts at compression have focused on identifying the parts of the data stream that need updating and limiting the transmissions to those parts. Further improvements in compression are realized by using the M-Protocol between the parts of the Acceleration Server.

Web browsing illustrates the benefits of Content Conversion. Web browsing using the EHU can be tedious unless the data displayed is tailored to the mobile device being used and the response time is kept fast by minimizing the round-trip data cycles to the EHU. For an EHU receiving HTTP content, the Acceleration Server using Web content conversion improves wireless web browsing by increasing the delivery speed of existing Internet content in the limited bandwidth environment. It is implemented using an M-Client front-end application working with an M-Server web proxy with EGTSS targeted extensions. This structure allows the Web browser to function as a matched data delivery system.

Currently, conventional web servers do not compress data and the conventional browser does not efficiently compress or decompress data for optimal display. The web browser can only display whatever it gets. Therefore, an acceleration server acts as a vital translation machine to process data between the browser and web servers and speeds data transmission while reformatting content to be displayed on multiple devices.

The EHU user requests information from the Web through its application using the M-Protocol platform. The conversion engine converts the EHU Web pages for minimum overhead and the Acceleration Server compresses the data for transmission to the EHU. The Web browser front-end then efficiently decompresses the data and displays it according to the capability of the device. The time of transmission is shortened by the compression ratio and further reduced by the conversion process limiting the overhead for a translation process.

The conversion engine for the Web proxy handles all data that passes to the EHU in all formats. A first implementation converter converts the TEXT/HTML, IMAGE/GIF and IMAGE/JPEG format types as illustrated in Table 1. For the HTML format, the engine analyzes all TAGs and performs modifications on the data files so that the resulting HTML frame can fit horizontally on the screens of most PDA devices. For the GIF format, the engine validates the file size, bypassing small files. It processes the file representing the image so that the output image only consists of the first frame that is properly resized, if needed, to fit the screens of most PDA devices. For the JPEG format, the engine treats the file similarly to the GIF file, except that it further fine tunes the JPEG quality, using techniques known in the industry. The conversion routine creates files that are smaller than the original files and passes the reformatted files to the M-Server where the files are further reduced in size by the compression algorithms. By combining the Web content conversion and the M-Protocol, the speed of transfer of screens is accelerated and the web's content is reformatted to fit on most PDA devices.

TABLE 1

| Data | |
|---|---|
| Format | Actions to Convert |
| HTML | Analyze tags |
| | Convert to fit PDA screen size |
| GIF | Validate File Size, bypass small |
| | files |
| | restrict image to first frame |
| | resize frame for PDA display |
| JPEG | Validate file size, bypass small |
| | files |
| | Restrict output image to first frame |
| | Fine tune JPEG quality |
| | resize for PDA display |

FIG. 11 illustrates an organization of applications working with the Acceleration Server in the M-Protocol environment to serve applications and specific platforms. An EHU 1102, such as a PDA, laptop, or extended telephone has an Acceleration Server client 1104 that coordinates traffic from applications in the EHU 1102 that need access to external data through the M-Connection to an acceleration Server 1114. The Acceleration Server client 1104 exchanges data files with the M-Client 1106 where decryption and decompression takes place. The Acceleration Server client 1102 coordinates exchanging data files with the appropriate application front end such as the Web browser 1108 or other application 1110 as needed. In the server 1114, the M-Server 1116 handles the verification, encryption and decryption of files for the M-Client 1106. The M-Server 1116 exchanges data files with other applications through the Acceleration Server 1130. In addition to the file manipulation required for applications like the Web content conversions 1122, the Acceleration Server 1130 maintains the network route map 1120, local data cache, data cache tag management and data caching maps 1118 for accelerated access to data for the clients as previously described. The route map function through the network 1126 may be invoked to assure fast access to remote data 1128 for instance.

The M-Server 1116 is structured to be modularized so that applications can use the Acceleration Server 1130 and M-Connection. Such applications may be developed using licensed components of the Acceleration Server and M-Protocol, may be integrated into the Acceleration Server and EHU, or may be developed by a specific user using a simple user interface to the components described above.

Since the M-Client decoder for each compression algorithm follows set procedures, execution of the decompression can be further accelerated by implementing the algorithm in hardware. The hardware implementation may allow alternate compression algorithms, specified by a user, to be executed in software.

The Acceleration Server may support applications to do more than graphical formatting, such as file formatting in a Java client/server system that can be used for a Java phone connection. The utility of the M-Protocol allows a seamless solution that is available for third parties that need to accommodate for mobile data.

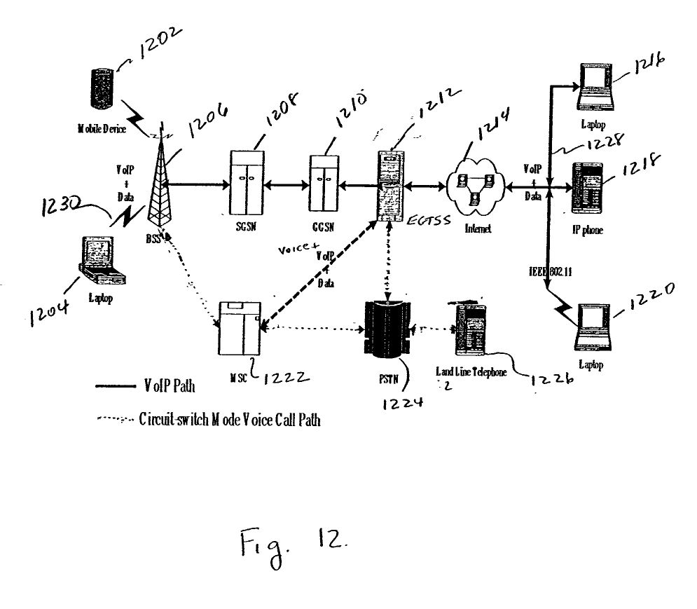

A specific application that uses the M-Protocol to expand the capabilities of the existing data lines, illustrated in FIG. 12 is Voice over IP (VoIP) in a GPRS environment. Without this application voice and data each use a separate channel in both GSM and GPRS. They cannot share a channel to carry both simultaneously. The current GPRS system is for data only. In order to receive voice calls, the client must also have a receiver for a separate GSM voice channel. When both data and voice applications are required, voice must still come on the circuit switched GSM channel and the data comes through the GPRS data packet channel. Because the two channels use the same radio frequencies, interference is likely creating problems as well as increasing the cost of the connection.

VoIP is not commonly used currently because both parties must simultaneously be in front of computers that have the appropriate VoIP software installed. Furthermore, when the data packets carrying VoIP are traveling through the Internet, the required Quality of Services (QoS) cannot be met due to packet loss and delays in the congested Internet.

In FIG. 12, the traditional connections for telephones, whether landline-to-landline or IP-to-IP (using VoIP) are not shown since a direct connection using the appropriate technology is well know. Using the M-Connection, calls from unlike devices are readily supported as illustrated in Table 2. The routing of voice over current GSM networks is designated by the dotted lines. A mobile call from a wireless phone such as mobile device 1202 connects through the Base Service system (BSS) 1206, to the Mobile Switching Center (MSC) 1222 of the mobile operator via either an H.323 or Codec standard connection and is routed to either the public phone network (PSTN) 1224 or other mobile networks.

TABLE 2

| | |
|---|---|
| From | Route |

Routes to a Land-Line Phone

| | |
|---|---|
| LL Phone | Traditional Way |
| IP Phone | VoIP -> IP Local EGTSS Server (Routing) |
| | -> nets -> LL Local EGTSS (Digital to |
| | Analog) -> PSTN |
| Wireless | BSS -> MSC -> PSTN |
| Phone | |
| Laptop | VoIP -> BSS -> SGSN -> GCSN -> EGTSS |
| | (Digital to analog) - > PSTN |

Routes to an IP phone

| | |
|---|---|
| IP Phone | Traditional Way |
| LL Phone | PSTN -> EGTSS (Analog to Digital and |
| | Routing) |
| Wireless | BSS -> MSC -> EGTSS (Analog to Digital |
| | and Routing) |
| Laptop | BSS -> SGSN -> CGSN -> EGTSS (Routing) |

In the GSM system data is routed through the MSC 1222 to the EGTSS server 1212. If a VoIP call is initiated from the backend network 1228 (Internet, private [corporate] network or other wireless data networks such as IEEE 802.11) the EGTSS server will convert it into the H.323 or Codec type voice calls and route it to the appropriate PSTN 1224 or mobile voice networks. Since VoIP looks like data in this system, any VoIP traveling through the GSM portion of the network (BSS 1206 and MSC 1222 ) will be significantly slowed by the GSM speed constraints.

In a GPRS system, the data packet (VoIP is a form of packet data) is routed from the GPRS Gateway Support Node (GGSN) 1210 to the EGTSS server 1212 and either continues as a VoIP call to the backend data network 1228 or is converted to an H.323 or Codec type voice call to traverse the conventional voice networks. In this environment using M-Connection links, the digital link 1230, that could be carrying Web information, can accommodate the VoIP connection also. For GPRS, the digital link is received at the BSS 1206, but is passed through the System Gateway Support Node(SGSN) 1208 to the GPRS Gateway Support Node (GCSN) 1210 to the EGTSS server 1212. In the server 1212, the VoIP packets are passed to an application that determines whether to convert them or continue passing on the VoIP packets.

The compression/acceleration function of the M-Connection plays an essential role in allowing VoIP to function under GPRS's limited bandwidth with high QoS. The M-Protocol allows VoIP and data to traverse the network without requiring separate systems. The compression and acceleration effectively increase the bandwidth efficiencies because more applications can use the available transmission bandwidth. The M-Connection allows simultaneous data and voice applications to co-exist in a single client such as a smart phone, PDA phone or laptop with VoIP functions. Without the M-Protocol, simultaneous voice and data using one receiving channel it is not possible. With M-Connection carrying VoIP, both voice and data come as a packet. The simultaneous voice and data applications operate as cooperatively as if an application were downloading from a web site that has sound, text and graphics.

Packaging VoIP in M-Protocol packets allows VoIP to be deployed seamlessly and circumvents the QoS problems and need for specialized equipment. The Acceleration Server routes data, including VoIP, to the appropriate IP addresses so that normal voice calls can be transformed from analog voice to digital data using a voice-to-data gateway. The voice to data gateway fits in the original Acceleration Server as it performs the IP issuing, IP routing, authentication and other related functions.

The fact that the M-Connection allows VoIP to work in GSM, GPRS and PSTN network environments has significant utility in providing a unified voice and data communication system to be deployed by telecoms and others, such as virtual network operators, who lease GSM airtimes. Here, the M-Connection optimizes the mobile operators' bandwidth by routing data and voice to other networks, effectively allowing more calls to be run through the mobile network.

Having described preferred embodiments of the invention it will now become apparent to those of ordinary skill in the art that other embodiments incorporating these concepts may be used. Accordingly, it is submitted that the invention should not be limited by the described embodiments but rather should only be limited by the spirit and scope of the appended claims.

What is claimed is:

1. A method for encapsulating a message in a sequence of packets being transported by the TCP/IP protocol comprising:
adding a data transformation header to the front of the data file, the data transformation header specifying processes applied to the data field.

2. The method of claim 1 wherein the process is encryption of a content field.

3. The method of claim 1 wherein the process is compression of the content field.

4. The method of claim 1 wherein the process is cyclic redundancy checking of the content filed.

5. The method of claim 1 wherein the process is incorporating a system header into the content field.

6. A packet network, comprising:
a sending node for receiving a communication from an application resident on the node, processing a data file according to the client node's preset conditions creating a processed data file, and incorporating a control word identifying the processes used in a data transformation header appended to the processed data file to form a datagram, the sending node utilizing a TCP/IP protocol to forward the datagram on the packet network; and
a receiving node for receiving the datagram, interpreting the control word of the data transformation header to reconstruct the data file and passing the data file to an application on the receiving node.

7. The packet network of claim 6 wherein the process is encryption of a content field.

8. The packet network of claim 6 wherein the process is compression of the content field.

9. The packet network of claim 6 wherein the process is cyclic redundancy checking of the content filed.

10. The packet network of claim 6 wherein the process is incorporating a system header into the content field.

11. A processing system operating in conjunction with a packet-based communication system to speed retrieval of Web pages for an extended handheld device, the processing system comprising:
a request forwarder for interpreting a user's Web request and forwarding it;
an acceleration server for retrieving a requested Web page from the Web, for converting the requested page to reformatted page tailored for the extended handheld device, and for forwarding the reformatted page to the user; and
a protocol provider, resident in nodes of the packet-based communication system, for compressing messages between the request forwarder and the acceleration server to minimize a communication time between them.

12. A system for delivering a voice message to an intended recipient, comprising:
a converter program for converting a voice signal to digital packets for transport over an IP network;
a packager program for placing the digital packets in a compressed format;
an acceleration program for determining a route to a node near the recipient;
an unpacking and converting program for constituting the received voice message into a format needed by the recipient.
